(19) United States
(12) Patent Application Publication
(10) Pub. No.: US 2023/0372748 A1
(43) Pub. Date: Nov. 23, 2023

(54) MASK

(71) Applicant: Kyung Ah PARK, Seoul (KR)

(72) Inventor: Kyung Ah PARK, Seoul (KR)

(21) Appl. No.: 18/034,348

(22) PCT Filed: Oct. 27, 2021
(86) PCT No.: PCT/KR2021/015152

§ 371 Date: Apr. 27, 2023

(30) Foreign Application Priority Data
Oct. 27, 2020 (KR) 10-2020-0140382

(51) Int. Cl. A62B 23/02; A62B 18/08; H04R 1/02; G10L 15/26; G06F 40/58; A41D 13/11

(52) U.S. Cl. CPC A62B 23/025; A62B 18/08; H04R 1/028; G10L 15/26; G06F 40/58; A41D 13/1107; A62B 18/084

(57) ABSTRACT

A mask according to one embodiment of the present invention is worn on the face of a user, and comprises: a mask body made from a first transparent material; and a filter unit coupled to the mask body and made from a material through which air can be ventilated, wherein the mask body is formed in a region corresponding to the nose and mouth of the user.

### TECHNICAL FIELD

The present disclosure relates to a mask and, more specifically, to a mask capable of enabling the mouth and nose of a user to be checked from the outside and at the same time ensuring the user's comfortable breathing.

### BACKGROUND ART

In general, a mask is worn to block pathogens such as viruses or foreign substances such as fine dust in the air from being inhaled through a person's mouth or nose into the respiratory system, or prevent pathogenic microorganisms from being released through the mouth or nose of a patient to the outside and infecting others.

In particular, recently, due to the highly contagious COVID-19, the importance of wearing a mask has emerged as a very important issue, and it is widely known that only wearing a mask can effectively block the transmission of viruses by droplets or the like.

In the case of a conventional mask, it is made of a non-woven material for filtering not only droplets but also fine particles that can float in the air, so that part of the user's face is not exposed to the outside.

In the case of such a conventional mask, it is impossible for people in the service industry to instill trust in customers. Furthermore, there was a problem that it caused difficulties in communication for hearing-impaired people who communicate by reading the mouth of the other person with their eye.

In order to solve these conventional problems, transparent masks made of various types of transparent silicone or plastic resin have been proposed. However, such a transparent mask still has problems in that the mask does not adhere well to a user's face. Furthermore, in order to solve the ventilation problem, it is necessary to additionally prepare a complicatedly configured ventilation member, which increases the price of such a product.

### DETAILED DESCRIPTION

### Technical Problem

According to an embodiment of the present disclosure, a mask aims to solve the above problems.

Therefore, it is an object of the present disclosure to provide a mask capable of enabling the mouth and nose of a user to be checked from the outside and at the same time ensuring the user's comfortable breathing.

Problem solutions of the present disclosure are not limited to those mentioned above, and other problem solutions not mentioned will be clearly understood by those skilled in the art from the description below.

### Problem Solving Means

According to an embodiment of the present disclosure, a mask to be worn on a user's face, includes: a mask body made from a first transparent material; and a filter unit, which is coupled to the mask body and made from a material through which air can be ventilated, wherein the mask body is formed in a region corresponding to the nose and mouth of the user.

It is preferable that the mask body includes a first area formed at an upper portion and a second area formed by extending in a downward direction from the first area, and the width of the first area is greater than the width of the second area.

It is preferable that the filter unit is coupled to the mask body so as to be disposed at both sides of the second area.

It is preferable that an elastic member is disposed on an inner surface of an area which is not coupled to the filter unit in peripheral parts of the mask body.

It is preferable that the elastic member is formed of a second transparent material different from the first transparent material.

It is preferable that the elastic member is formed so as to be in close contact with the user's face, and the mask body is formed so as to be spaced apart from the user's face.

It is preferable that a moisture absorber is coated on an inner surface of the mask body.

It is preferable that the filter unit is formed so as to be detachable from the mask body.

It is preferable that the mask further includes a fixing unit coupled to the mask body or the filter unit so as to fix the mask to the user's face.

It is preferable that a hollow portion is formed in the filter unit, and the mask body is disposed in the hollow portion of the filter unit.

It is preferable that inside of a first edge in the filter unit, which is connected to the mask body, is formed so as to be spaced apart from the user's face, and inside of a second edge in the filter unit, which is not connected to the mask body, is formed so as to come into contact with the user's face.

It is preferable that the filter unit includes a first filter part, a second filter part, a third filter part and a fourth filter part respectively coupled to upper and lower portions and one side and the other side of the mask body, the first filter part to the fourth filter part are integrally formed, the first filter part includes an adjusting member for allowing an upper portion of the filter unit to come into contact with the shape of an upper portion of the user's nose, and the second filter part is provided with a seating part for seating the chin of the user on a lower portion of the filter unit.

It is preferable that areas adjacent to the mask body in the third filter part and the fourth filter part are formed to be spaced apart from the user's face, when the user wears the mask.

It is preferable that the mask further includes: a microphone, which is disposed on the mask body and receives voice of the user; a control unit for converting the user's voice acquired by the microphone into text; and a display for outputting the text converted by the control unit.

It is preferable that the control unit translates voice of a first language inputted through the microphone into text of a second language and outputs the text of the second language to the display.

It is preferable that the display is a transparent display.

### Effects of the Inventive Concept

According to an embodiment of the present disclosure, a mask includes a filter unit, which is formed of a material capable of ventilation and has a hollow portion formed therein, and a mask body, which is made of a transparent material and disposed in the hollow portion of the filter unit, wherein the hollow portion is formed in a region corresponding to the nose and mouth of a user so that the user's mouth and nose can be checked from the outside and at the same time the user's comfortable breathing can be guaranteed.

The effects of the present disclosure are not limited to those mentioned above, and other effects not mentioned will be clearly understood by those skilled in the art from the description below.

### BRIEF DESCRIPTION OF THE DRAWINGS

FIG. 1 is a view for showing a mask according to a first embodiment of the present disclosure.

FIG. 2 is a view for showing a mask according to a second embodiment of the present disclosure.

FIG. 3 and FIG. 4 are views for showing modified examples of the first embodiment and the second embodiment of the present disclosure, respectively.

FIG. 5 is a cross-sectional view for showing the configuration of a replacement notification module, and

FIG. 6 and FIG. 7 are views showing cross sections of a fragrance capsule in FIG. 5, respectively.

### BEST MODE

Preferred embodiments according to the present disclosure will be described in detail with reference to the accompanying drawings, but the same or similar elements will be given the same reference numerals, and redundant descriptions thereof will be omitted.

In addition, in describing the present disclosure, if it is determined that detailed description of a related known technology may obscure the gist of the present disclosure, the detailed description thereof will be omitted. In addition, it should be noted that the accompanying drawings are only for easy understanding of the concept of the present disclosure and should not be construed as limiting the concept of the present disclosure by the accompanying drawings.

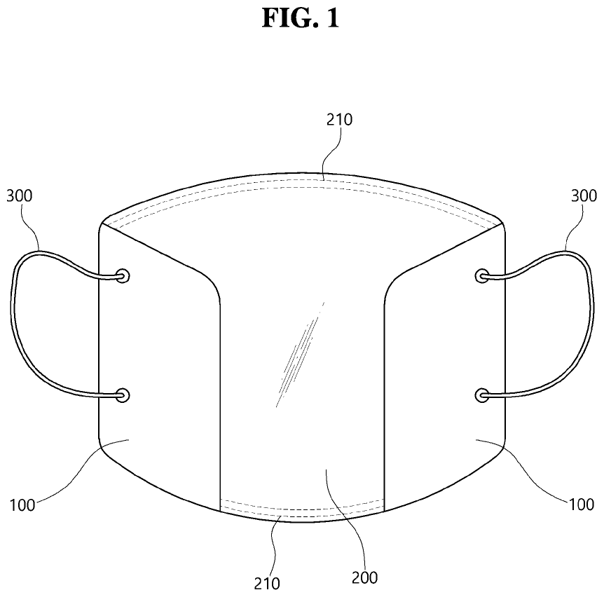

First, referring to FIG. 1, a mask according to a first embodiment of the present disclosure will be described.

The mask according to the first embodiment of the present disclosure relates to a mask to be worn on a user's face, and includes a filter unit 100, a mask body 200 and a fixing unit 300, as shown in FIG. 1.

The mask body 200 is formed of a first transparent material such as transparent polypropylene resin, and the filter unit 100 is coupled to the mask body 200 and is formed of a breathable material such as non-woven fabric.

In particular, the mask body 200 is preferably formed in a region corresponding to the user's nose and mouth so that the face including the user's mouth can be checked from the outside.

Meanwhile, the mask body 200 made of the first transparent material may have a problem in that the user's breathing may be uncomfortable due to poor air permeability and the mask body 200 is moistened by the air coming out of the user's mouth and nose.

In order to avoid the above problems, in the mask according to an embodiment of the present disclosure, the mask body 200 has a first area formed at an upper portion and a second area formed by extending downward from the first area, wherein the width of the first area may be greater than the width of the second area.

Herein, the filter unit 100 is coupled to the mask body 200 so as to be disposed at both sides of the second area, as shown in FIG. 1. As a result, the filter unit 100 can be placed adjacent to the user's mouth and nose. Therefore, it is possible to facilitate the user's breathing and at the same time solve the problem of moisture in the mask body 200.

Meanwhile, since the filter unit 100 is formed of a material such as non-woven fabric, which has elasticity, the inside of the peripheral part of the filter unit 100 comes into contact with the user's face. However, In the case of the mask body 200, since the first transparent material is a transparent resin having no elasticity, the mask body 200 cannot come into contact with the user's face, and thus the airtightness of the mask is not guaranteed.

In order to avoid the problem, an elastic member 210 is disposed on an inner surface of an area, which is not coupled to the filter unit 200 in peripheral parts of the mask body 200, so that the peripheral parts of the mask body 200 can be brought into close contact with the user's face.

In particular, when the elastic member 210 is formed of a non-transparent material, it covers part of the user's face exposed through the mask body 200. Therefore, it is preferable that the elastic member 210 is formed of a second transparent material different from the first transparent material of the mask body 200, wherein the second transparent material may be a material having transparency and elasticity such as transparent silicon.

At this time, the elastic member 210 should be formed so as to be in close contact with the user's face, and the mask body 200 should be formed so as to be spaced apart from the user's face.

Furthermore, since an inner surface of the mask body 200 may become damp when the user breathes, in order to prevent this, it is preferable to coat the inner surface of the mask body 200 with a moisture absorber.

In addition, Zion pigment, which changes color depending on the temperature, can be applied to a specific area of the filter unit 100, through which it is possible to easily determine whether the user becomes hot from the outside.

In particular, the Zion pigment must be disposed on a part of the filter unit 100 that comes into contact with the user's face so as to accurately reflect the user's body temperature, the Zion pigment is preferably applied to the edge of the filter unit 100.

In addition, the filter unit 100 and the mask body 200 may be detachably formed, and thus the mask body 200 made of a transparent material may be reused several times.

Meanwhile, the mask according to the first embodiment of the present disclosure includes a fixing unit 300 for fixing the mask to the user's face, and this fixing unit 300 may be coupled to the filter unit 100, and may also be coupled to the mask body 200.

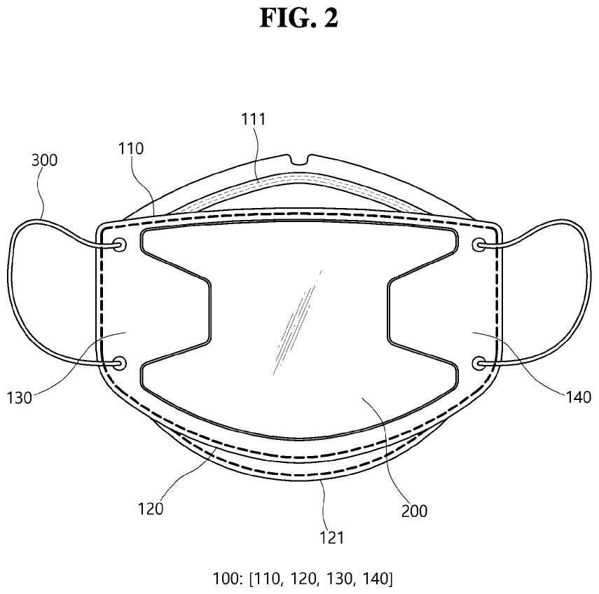

Hereinafter, a mask according to a second embodiment of the present disclosure will be described with reference to FIG. 2.

The mask according to the second embodiment of the present disclosure relates to a mask to be worn on a user's face, and includes a filter unit 100, a mask body 200 and a fixing unit 300, as shown in FIG. 2.

The filter unit 100 has a hollow portion formed therein and is formed of a breathable material such as non-woven fabric. The mask body 200 is disposed in the hollow portion of the filter unit 100, and is formed of a transparent material such as transparent silicone or transparent polypropylene resin.

Herein, the hollow portion formed in the filter unit 100 is formed in a region corresponding to the user's nose and mouth, the mask body 200 is fused to a lower surface of an inner peripheral part of the filter unit 100. As a result, the transparent mask body 200 is disposed in the region corresponding to the user's nose and mouth, so that the user's nose and mouth can be seen from the outside when the user wears the mask.

Herein, it is preferable that inside of a first edge in the filter unit, which is connected to the mask body, is formed so as to be spaced apart from the user's face, and inside of a second edge in the filter unit, which is not connected to the mask body, is formed so as to come into contact with the user's face.

*In addition, the filter unit 100 can be divided into a first filter part 110, a second filter part 120, a third filter part 130 and a fourth filter part 140 on the basis of the hollow portion.

Specifically, as shown in FIG. 2, the first filter part 110 is disposed at an upper portion of the mask body 200, the second filter part 120 is disposed at a lower portion of the mask body, the third filter part 130 is disposed at one side of the mask body 200, and the fourth filter part 140 is disposed at the other side of the mask body 200.

As described above, the filter unit 100 is made of a breathable material and is formed of a material that can adhere to the user's face. Therefore, even if the mask body 200 does not come into close contact with the user's face due to the material characteristics of the mask body 200, ends of the first filter part 110 to the fourth filter part 140 are all in close contact with the user's face, so airtightness is guaranteed when the user wears the mask.

In particular, in consideration of the fact that each user has a different nose shape, in order to bring an upper portion of the filter unit 100 into contact with an upper portion of the user's nose, an adjusting member 111 may be provided to the first filter part 110, and this adjusting member 111 may be a thin metal wire.

In addition, the second filter part 120 may be provided with a seating part 121 so that the user's chin can be seated on a lower portion of the filter unit 100, thereby ensuring stable airtightness of the mask.

Meanwhile, the mask body 200 allow air permeation due to the material characteristics of the mask body 200, and eventually the user proceeds to breathe through the filter unit 100. In order to ensure the user's smooth breathing, it is preferable to form the filter unit 100 not only in the part in contact with the user's face, but also around the user's mouth and nose.

To this end, it is preferable that the third filter part 130 and fourth filter part 140 are formed to extend to areas adjacent to the user's nose and mouth, as shown in FIG. 1.

Specifically, as shown in FIG. 1, the width of the upper and lower portions of the mask body 200 can be formed larger than the width of the middle part of the mask body 200, so that the user's mouth and nose can be seen from the outside and at the same time the user's smooth breathing is also facilitated.

In particular, if both the third filter part 130 and fourth filter part 140 come entirely into close contact with the user's face, the user's breathing may be interfered. Therefore, it is preferable that areas of the third filter part 130 and fourth filter part 140, which are adjacent to the mask body, are formed so as to be spaced apart from the user's face, when a user wears the mask.

Furthermore, since an inner surface of the mask body 200 may become damp when the user breathes, in order to prevent this, it is preferable to coat the inner surface of the mask body 200 with a moisture absorber.

In addition, Zion pigment, which changes color depending on the temperature, can be applied to a specific area of the filter unit 100, through which it is possible to easily determine whether the user becomes hot from the outside.

In particular, the Zion pigment must be disposed on a part of the filter unit 100 that comes into contact with the user's face so as to accurately reflect the user's body temperature, the Zion pigment is preferably applied to the edge of the filter unit 100.

In addition, the filter unit 100 and the mask body 200 may be detachably formed, and thus the mask body 200 made of a transparent material may be reused several times.

Meanwhile, the mask according to the second embodiment of the present disclosure includes a fixing unit 300 for fixing the mask to the user's face, and this fixing unit 300 may be coupled to the filter unit 100, and may also be coupled to the mask body 200.

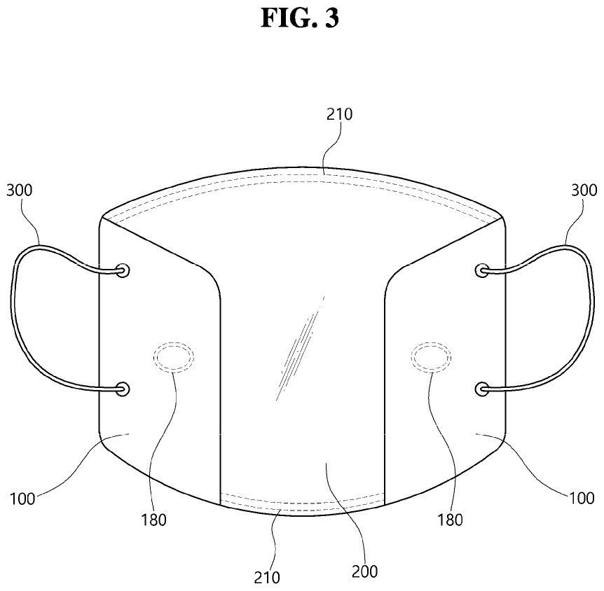

Hereinafter, modifications of the mask according to the first and second embodiments of the present disclosure will be described with reference to FIG. 3 to FIG. 7, in which detailed description of the same features as those of the masks according to the first and second embodiments of the present disclosure described above will be omitted.

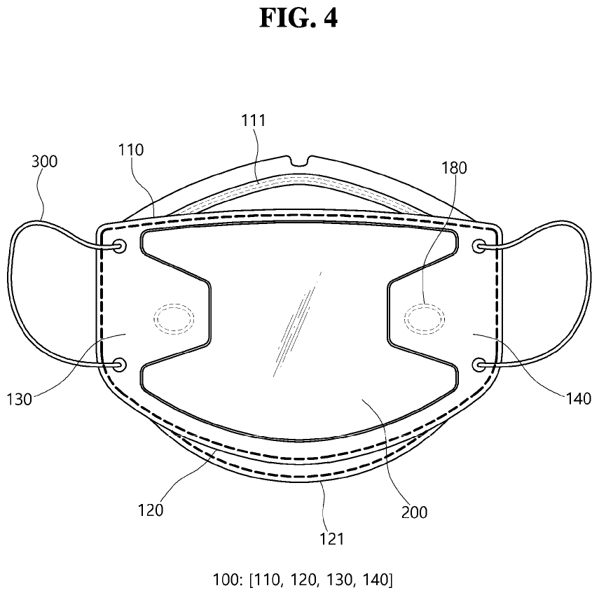

Referring to FIG. 3 and FIG. 4, the masks according to the first and second embodiments of the present disclosure are configured to further include replacement notification modules 180 in addition to the masks according to the first and second embodiments of the present disclosure, wherein the replacement notification modules 180 are means for allowing users to quickly know replacement cycles of the masks.

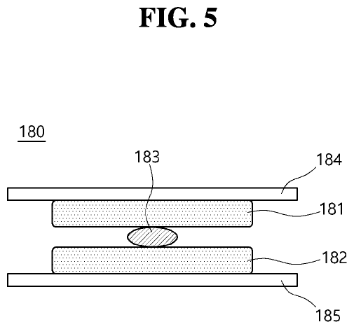

The replacement notification module 180 is preferably disposed in an area of the filter unit 100, which is adjacent to the mask body, as shown in FIG. 3 and FIG. 4. In addition, the replacement notification module 180 includes a first expansion unit 181, a second expansion unit 182, a fragrance capsule 183, a first support unit 184 and a second support unit 185, as shown in FIG. 5.

The first expansion unit 181 and the second expansion unit 182 are disposed so as to face each other within a receiving portion of a second sheet 160, wherein the first expansion unit 181 and the second expansion unit 182 contain bentonite therein so as to absorb moisture and expand beyond their own basic volume when coming into contact with moisture and include semi-permeable membranes which have permeability and are formed on the outside thereof so as to surround the bentonite.

In particular, it is preferable that the semi-permeable membrane is formed so as to allow permeation in a single direction only so that moisture can flow into the inside from the outside but moisture does not flow from the inside to the outside.

Bentonite refers to clay mineral, that is, a type of metamorphic rock mainly containing montmorillonite, which is mineral belonging to the monoclinic system that forms crystal structures like mica, and has cation exchange, adsorption, and expansion properties, including nano-level microscopic type of microparticles.

Such bentonite not only has a unique property of expanding to 13 to 16 times its own volume by absorbing sufficient moisture based on its excellent adsorption and expansion properties. In addition, since bentonite is not chemically active, it does not chemically change itself or moisture through reaction with moisture, thereby ensuring chemical stability.

It is preferable that the bentonite used in the present invention has a moisture content (Free Moisture) of 10 to 14%, a swelling degree of 2 cc/g or more, a PH (5%, solution) of about 5.5 to 7.5, and a particle size (200 Mesh Pass) of 80% or more.

The first support unit 184 and the second support unit 185 are disposed on the outside of the first expansion unit 181 and on the outside of the second expansion unit 182, respectively, so as to support the first expansion unit 181 and the second expansion unit 182, respectively.

The fragrance capsule 183 is disposed between the inside of the first expansion unit 181 and the inside of the second expansion unit 182 and accommodates a preset flavoring material therein.

By the configuration of the replacement notification module 180 as described above, when a user wears the masks as shown in FIG. 3 and FIG. 4, the first expansion unit 181 and the second expansion unit 182 expand by continuously absorbing moisture generated during user's breathing.

The longer a user uses the mask, the larger the first expansion unit 181 and second expansion unit 182 expand.

As the first expansion unit 181 and second expansion unit 182 continue to expand, pressure is applied to the fragrance capsule 183. Finally, an outer shell of the fragrance capsule 183 is broken, and fragrance inside the fragrance capsule 183 spreads into a functional air filter fabric, that is, the inside of the mask. At this time, the user feels the scent inside the mask, and the user recognizes that it is time to replace the mask.

Meanwhile, there is a problem in that when the fragrance capsule 183 is destroyed, if the fragrance inside the fragrance capsule 183 is directly applied to the user's nose or mouth so that the user may feel uncomfortable.

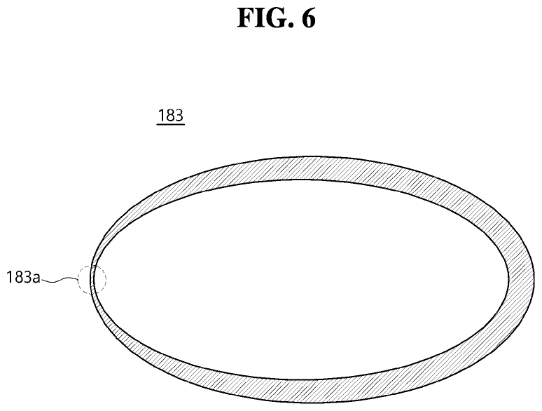

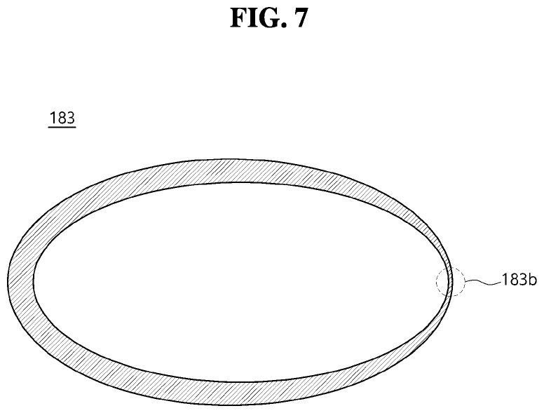

In order to avoid the problem, on the basis of FIG. 3 and FIG. 4, in the case of the replacement notification module 180 disposed at the left side, it is preferable that a first weak part 183a is formed at the left side in the outer shell of the fragrance capsule 183, as shown in FIG. 6. Likewise, in the case of the replacement notification module 180 disposed at the right side, it is preferable that a second weak part 183b is formed at the right side in the outer shell of the fragrance capsule 183, as shown in FIG. 7.

These first weak part 183a and second weak part 183b are formed thinner than the other portions in the outer skin, as shown in FIG. 6 and FIG. 7. Therefore, when external force is applied to the fragrance capsule 183 by the expansion of the first expansion unit 181 and the second expansion unit 182, the first weak part 183a and the second weak part 183b can be destroyed first. As a result, flavoring substances inside the fragrance capsule 183 are not delivered directly to the user's mouth or nose, but in the opposite direction to the user's mouth or nose, and thus it is possible to minimize the user's discomfort described above.

In addition, the masks according to the first and second embodiments of the present disclosure described above may further include a microphone, a control unit and a display.

The microphone is disposed on the mask body and receives voice of a user, the control unit converts the user's voice acquired by the microphone into text, and the display outputs the text converted by the control unit.

Furthermore, the control unit may be configured to translate voice of a first language inputted through the microphone into text of a second language and outputs the text of the second language to the display.

In particular, even if the control unit can perform the above described functions of conversion between voice and text and interpretation, in consideration of price competitiveness, the control unit can be configured to have only a wireless communication function, and the functions of conversion between voice and text and interpretation can be performed by an external server or a portable terminal.

Specifically, it is possible to provide configuration, in which when the control unit transmits user's voice received from the microphone to an external server or portable terminal, the external server or portable terminal converts the user's voice received from the control unit into text or converts the user's voice into text in another language through interpretation and transmits thus converted text back to the control unit, so that the control unit outputs the text received from the external server or portable terminal to the display.

Meanwhile, in order to prevent a situation in which the display disposed on the mask body 200 made from a transparent material covers a user's face that can be seen from the outside through the mask body 200, the display is preferably a transparent display.

The embodiments described herein and the accompanying drawings merely illustrate some of the technical ideas included in the present disclosure by way of example. Therefore, since the embodiments disclosed herein are not intended to limit the technical idea of the present disclosure, but are for explanation, it would be apparent that the scope of the technical idea of the present disclosure is not limited by these embodiments. Within the scope of the technical ideas contained in the description and drawings of the present disclosure, modified examples and specific embodiments that can be easily inferred by those skilled in the art should be construed as being included in the scope of the present disclosure.

What is claimed is:

1. A mask to be worn on a user's face, comprising:
a mask body made from a first transparent material; and
a filter unit, which is coupled to the mask body and made from a material through which air can be ventilated,
wherein the mask body is formed in a region corresponding to the nose and mouth of the user.

2. The mask according to claim 1, wherein the mask body includes a first area formed at an upper portion and a second area formed by extending in a downward direction from the first area, and the width of the first area is greater than the width of the second area.

3. The mask according to claim 1, wherein the filter unit is coupled to the mask body so as to be disposed at both sides of the second area.

4. The mask according to claim 1, wherein an elastic member is disposed on an inner surface of an area which is not coupled to the filter unit in peripheral parts of the mask body.

5. The mask according to claim 4, wherein the elastic member is formed of a second transparent material different from the first transparent material.

6. The mask according to claim 4, wherein the elastic member is formed so as to be in close contact with the user's face, and the mask body is formed so as to be spaced apart from the user's face.

7. The mask according to claim 1, wherein a moisture absorber is coated on an inner surface of the mask body.

8. The mask according to claim 1, wherein the filter unit is formed so as to be detachable from the mask body.

9. The mask according to claim 1, further comprising a fixing unit coupled to the mask body or the filter unit so as to fix the mask to the user's face.

10. The mask according to claim 1, wherein inside of a first edge in the filter unit, which is connected to the mask body, is formed so as to be spaced apart from the user's face, and inside of a second edge in the filter unit, which is not connected to the mask body, is formed so as to come into contact with the user's face.

11. The mask according to claim 10, wherein the filter unit includes a first filter part, a second filter part, a third filter part and a fourth filter part respectively coupled to upper and lower portions and one side and the other side of the mask body, the first filter part to the fourth filter part are integrally formed, the first filter part includes an adjusting member for allowing an upper portion of the filter unit to come into contact with the shape of the upper portion of the user's nose, and the second filter part is provided with a seating part for seating the chin of the user on a lower portion of the filter unit.

12. The mask according to claim 11, wherein areas adjacent to the mask body in the third filter part and the fourth filter part are formed to be spaced apart from the user's face, when the user wears the mask.

13. The mask according to claim 1, further comprising:
a microphone, which is disposed on the mask body and receives voice of the user;
a control unit for converting the user's voice acquired by the microphone into text; and
a display for outputting the text converted by the control unit.

14. The mask according to claim 13, wherein the control unit translates voice of a first language inputted through the microphone into text of a second language and outputs the text of the second language to the display.

15. The mask according to claim 13, wherein the display is a transparent display.
